(19) United States
(12) Patent Application Publication
(10) Pub. No.: US 2001/0033405 A1
(43) Pub. Date: Oct. 25, 2001

(54) Optical signal transmission device

(76) Inventors: Satoshi Kawai, Tokyo (JP); Atsushi Sasaki, Tokyo (JP); Shigeki Motomura, Tokyo (JP); Takayuki Matsuoka, Tokyo (JP); Eiji Ichii, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/761,532

(22) Filed: Jan. 16, 2001

(30) Foreign Application Priority Data
Jan. 13, 2000 (JP) 2000-4784

(51) Int. Cl. H04B 10/00

(52) U.S. Cl. 359/144; 359/169

(57) ABSTRACT

An optical signal transmission device includes an emitter, a receiver, and a reflector. The emitter includes a light-emitting element having an optical axis thereof deviating from a first propagation path toward a second propagation path such that a ratio of an incident intensity, at the receiver, of a second optical signal propagating along the second propagation path to an incident intensity, at the receiver, of a first optical signal propagating along the first propagation path is equal to or higher than a predetermined value at or above which a faulty optical-signal transmission is not caused, whereby the second optical signal of a required level enters into the receiver for reliable and stable optical signal transmission.

### BACKGROUND OF THE INVENTION

1. Technical Field

The present invention relates to an optical signal transmission device for transmitting an optical signal used to control operation of a vehicle-mounted apparatus such as a seat unit, air conditioner, and audio system, and more particularly, to an optical signal transmission device for reliably and stably implementing optical signal transmission.

2. Related Art

A vehicle is mounted with various apparatuses for increasing the comfort of the driver and passengers, such as a seat unit for adjusting the position and posture of a seat. A typical seat unit is comprised of a seat adjuster for adjusting the height and longitudinal position of a seat and the inclination angle of a back rest, and an operating section including manual switches that are operable by the driver or passengers. The seat adjuster is provided with movable parts respectively coupled to the seat and the back rest, and electric motors for driving the movable parts under the control of a control unit responsive to a manual switch operation, Generally, the control unit serves to control operations of vehicle-mounted apparatuses other than the seat unit.

In the seat unit of the aforementioned type, the operating section, motors, control unit and power source are generally connected to one another through wire harnesses arranged around the seat adjuster. Thus, a wire harness may bite into a movable part of the seat adjuster, causing an operational failure of the seat adjuster and damage to the wire harness.

In order to eliminate such problems, attempts have been made to reduce the number or diameter of wire harnesses so as to prevent the interference between the wire harnesses and the movable parts of the seat adjuster. For example, instead of using a configuration for supplying electrical signals from the operating section to the control unit through a wire harness, an attempt has been made to use an optical signal transmission device for propagating optical signals through a free space from the operating section to the control unit. For instance, such a transmission device comprises an emitter and a receiver provided in the operating section and the control unit, respectively, so that an optical signal emitted from the emitter may be received by the receiver.

With the aforementioned transmission device, if an obstacle is present on the optical-signal propagation path extending between the emitter and the receiver, optical signal transmission therebetween is prevented. For instance, in the case of a transmission device mounted to the seat unit, a movable part of the seat adjuster or a wire harness can be moved, during the operation of the adjuster, into the propagation path to prevent optical signal transmission.

With regard to this problem, a light space-transmission device is disclosed in Japanese provisional patent publication no. 3-40616, which is so designed that part of an optical signal emitted from a light transmitter is reflected by a reflector disposed away from a location where an obstacle may be present, and part of the reflected optical signal is received by a light receiver.

Thus, in order to eliminate a faulty transmission, a reflector may be provided in or around the seat unit in accordance with the teaching of the aforementioned publication, to enable the transmission device mounted to the seat unit to effect optical signal transmission even if an obstacle is present on the propagation path.

However, the light space-transmission device described in the publication is adapted for remote control of a video system or for space transmission of sound signals in a house. Thus, by simply applying the teaching of the publication to a transmission device for use in a vehicle-mounted apparatus, it is difficult to obtain a transmission device free from a faulty transmission caused by an obstacle. Reasons why such a difficulty is encountered are as follows:

An optical signal transmission device for a seat unit, to which the teaching of the aforementioned publication is applied, may be comprised of an emitter provided in the operating section, a receiver provided in the control unit, and a reflector for reflecting the optical signal emitted from the emitter toward the receiver. The emitter and the receiver have directivity characteristics. The optical signal emitted from the emitter is comprised of signal components emitted in various directions at different emission angles with respect to the optical axis of the emitter. The emission intensity of the signal component is determined in accordance with the directivity characteristic, i.e., the emission angle vs. emission intensity characteristic. Hereinafter, an optical-signal propagation path extending between the emitter and the receiver will be referred to as a first propagation path, and a propagation path extending between the emitter, reflector and receiver will be referred to as a second propagation path, which is comprised of upstream and downstream sections thereof extending between the emitter and the reflector and between the reflector and the receiver, respectively.

In the transmission device of this kind, the position for installation of the reflector must be determined so that the upstream and downstream sections of the second propagation path may extend at a large angle with respect to the first propagation path, to enable optical signal transmission along the second propagation path when an obstacle is present on the first propagation path. On the other hand, light-emitting and light-receiving elements individually constituting the emitter and the receiver have their directivity characteristics, and there is a restriction in a vehicle-mounted apparatus as to kinds of reflector members that can constitute the reflector. Therefore, the optical signal (hereinafter referred to as “second optical signal” or “reflected optical signal”) that propagates along the second propagation path is considerably low in its incident intensity at the receiver, as compared to the incident Intensity of the optical signal (hereinafter referred to as “first optical signal” or “direct optical signal”) that propagates along the first propagation path. Thus, a faulty transmission may be caused, If an obstacle is present on the first propagation path.

The following is a more concrete explanation as to the above situation. The light-emitting and light-receiving elements of the transmission device have directivity characteristics as shown in FIGS. 11 and 12. In a case where the transmission device is configured that each of the upstream and downstream sections of the second propagation path extends at an angle of 30 deg, for instance, with respect to the first propagation path, a relative intensity of the second optical signal to the first optical signal at the light-emitting element is 30% in accordance with the directivity characteristic of the light-emitting element. Further, a relative intensity of the second optical signal to the first optical signal at the light-receiving element is 90% in accordance with the directivity characteristic of the light-receiving element, if the first and second optical signals have the same intensity just before the entry into the light-receiving element. A relative intensity (reflection factor) before and after reflection at the reflector is 25% if the seat cushion frame made of iron is utilized as the reflector out of the seat-cushion components listed in Table 1.

Consequently, in the transmission device having the aforementioned construction, a relative intensity of the second optical signal to the first optical signal at the light-receiving element is represented by the product of the just-mentioned three relative intensities, which is about 7%.

As apparent from Table 1, the seat cushion frame has the highest reflection factor of 25% among the seat unit components. Thus, the relative intensity of the reflected optical signal to the direct optical signal at the entry to the light-receiving element is further lowered, if the reflector is composed of another seat unit component.

TABLE 1

| Name of seat unit component | Reflection factor (%) |
|---|---|
| Seat cushion frame | 25 |
| Motor | 10 |
| Protector | 5 |
| Vinyl tape | 2 |
| Floor carpet | <1 |

The reflection factors shown In Table 1 are values measured using light having a wavelength of 950 nm.

As explained above, in the optical signal transmission device mounted to a vehicle-mounted apparatus, the incident intensity of the reflected optical signal greatly decreases as compared to that of the direct optical signal. Thus, a faulty transmission may be caused when the direct optical signal is blocked.

A faulty transmission caused by a low-level reflected optical signal may be prevented by providing an amplifier circuit in the receiver to amplify the reflected optical signal, or by providing the receiver with a highly sensitive light-receiving element which can receive a low-level reflected optical signal, or by using the reflector having a high reflection factor. However, these measures make the optical signal transmission device high-priced or require a modification of an existing vehicle-mounted apparatus to which the transmission device is mounted.

### SUMMARY OF THE INVENTION

An object of the present invention is to provide an optical signal transmission device capable of effecting a reliable and stable optical signal transmission In a vehicle-mounted apparatus such as a seat unit, air conditioner, and audio system, without the need of taking special measures such as the provision of an amplifier circuit.

According to one aspect of the present invention, there is provided an optical signal transmission device, mounted to a vehicle, for propagating an optical signal, used to control operation of a vehicle-mounted apparatus, through a free space along a first propagation path extending from an emitter to a receiver and a second propagation path extending from the emitter to the receiver via a reflector that is disposed outside the emitter and the receiver. In this transmission device, an optical axis of a light-emitting element of the emitter or that of a light-receiving element of the receiver is deviated such that a ratio of an incident intensity, at the receiver, of a second optical signal propagating along the second propagation path to an incident intensity, at the receiver, of a first optical signal propagating along the first propagation path is equal to or higher than a predetermined value at or above which a faulty optical-signal transmission is not caused.

In the present invention, the optical axis of the light-emitting element or the light-receiving element is deviated, e.g., from the first propagation path toward the second propagation path, and the light-emitting element generally has a directivity characteristic, steeper than that of the light-receiving element, to provide a lower optical-signal emission intensity with increase of an angle formed between the direction of emission of the optical signal and the optical axis of the light-emitting element. Thus, as compared to a case where the optical axis of the light-emitting element coincides with the first propagation path, the optical-signal emission intensity from the light-emitting element becomes smaller on the first propagation path and larger on the second propagation path, so that the ratio of the incident intensity of the second optical signal to that of the first optical signal at the light-receiving element becomes larger. The deviation of optical axis of the light-emitting element or the light-receiving element, e.g., from the first propagation path is set such that the ratio of incident intensities becomes equal to or larger than a predetermined value, e.g., 25%. Therefore, even if the first optical signal is blocked, e.g., by an obstacle, the second optical signal at a required level enters into the receiver, so that a faulty transmission is not caused. Further, it is unnecessary to use a highly sensitive light-emitting element and/or a highly sensitive light-receiving element or to provide the receiver with an amplifier circuit for amplifying the optical signal, whereby a low-priced optical signal transmission device can be provided. In addition, even if the reflector is comprised of a member having a low reflection factor, the second optical signal of a required level is obtainable, so that the reflector may be comprised of a component part of a vehicle or vehicle-mounted apparatus, making it possible to reduce the cost of the transmission device.

In the present invention, at least one of the light-emitting element of the emitter and the light-receiving element of the receiver is disposed upward.

The optical signal transmission device used to control operation of a vehicle-mounted apparatus is installed in a vehicle, e.g., on a vehicle floor on which dust is liable to be built up. On the other hand, a faulty transmission may be caused, if dust is adhered to the light-emitting and light-receiving elements of the transmission device. The adherence of dust rising from the vehicle floor may be alleviated by disposing these elements away from the vehicle floor, for example. However, there is a restriction as to the location available for installation of the transmission device. With the preferred transmission device having the light-emitting and light-receiving elements at least one of which is disposed upward, dust especially large-size dust rising from the vehicle floor is suppressed from being adhered to the light-emitting element and/or the light-receiving element even if the transmission device is disposed close to the vehicle floor, thereby preventing a faulty transmission caused by adherence of dust.

According to another aspect of the present invention, there is provided an optical signal transmission device, mounted on a vehicle, for propagating an optical signal, used to control operation of a vehicle-mounted apparatus, through a free space from an emitter to a receiver. The transmission device has a reflector disposed outside the emitter and the receiver and formed with first and second slanted reflection planes, and the emitter includes a light-emitting element having an optical axis thereof deviating from an imaginary line connecting the emitter and the receiver toward the reflector such that a ratio between incident intensities of first and second optical signals, emitted from the emitter, reflected individually by the first and second slanted reflection planes and then entering the receiver, is equal to or higher than a predetermined value, e.g., 25%, at or above which a faulty optical signal transmission is not caused.

In the present invention, the first and second optical signals emitted from the light-emitting element having its optical axis deviating toward the reflector from the imaginary line connecting between the emitter and the receiver are reflected by the first and second slanted reflection planes of the reflector toward the receiver, so that two optical-signal propagation paths are formed between the emitter and the receiver to increase the optical-signal incident intensity at the receiver, whereby a proper optical signal transmission can be made from the emitter to the receiver via the reflector. In addition, the emitter and the receiver can be disposed close to the reflector in the direction as seen from a plane on which the transmission device is installed to the transmission device. That is, they can be installed away from the transmission device installation plane, thereby preventing dust rising from the installation plane from being adhered to the emitter and the receiver to prevent a faulty transmission.

In the transmission device according to the first aspect of this invention, the light-emitting element may be so disposed that its optical axis coincides with an upstream section, extending from the emitter to the reflector, of the second propagation path. In this case, the emission intensity of the second optical signal from the light-emitting element increases to its maximum, permitting the incident intensity of the second optical signal at the receiver to increase. In the transmission device according to the second aspect of this invention, the optical axis of the light-emitting element may be set to be directed to between the first and second slanted reflection planes, thereby increasing the intensity of the reflected optical signals.

In the transmission device according to the first aspect of this invention, if the transmission device is configured that a large angle is formed between the first and second propagation paths, the emitter may be comprised of a plurality of light-emitting elements for individually emitting the first and second optical signals, or may be comprised of a single light-emitting element for emitting both the optical signals. In the former case, an optical axis of the entirety of the plurality of light-emitting elements may be set to be deviated from the first propagation path toward the second propagation path. For example, the optical axes of the light-emitting elements for the first and second optical signals may coincide with the first and second propagation paths, respectively. The configuration of the former case makes it easy to set the propagation paths to form a large angle therebetween, and by using light-emitting elements that are relatively low in maximum light emission intensity, a reduction in cost can be achieved. In the case of using light-emitting elements having a relatively high maximum emission intensity, a driving current for the elements can be reduced to prolong their service life. On the other hand, in the latter case where the emitter is provided with a single light-emitting element, one or more reflector members may be disposed in either or both of upstream sections, extending in the emitter, of the first and second propagation paths, making it easy to arrange the first and second propagation paths to form a large angle therebetween. Since there is little restriction as to the constituent material of the reflector member disposed in the emitter, the reflector member may be made from a material having a high reflection factor, thereby avoiding a decrease in the intensity of the first or second optical signal.

### BRIEF DESCRIPTION OF THE DRAWINGS

FIG. 1 is an exploded perspective view showing a primary part of a seat unit on which an optical signal transmission device of this invention is mounted:

FIG. 2 is a schematic view showing an emitter of an optical signal transmission device according to a first embodiment of this invention;

FIG. 3 is a schematic side view showing an arrangement of a seat switch unit and a position control unit in the first embodiment;

FIG. 4 is a view depicting a positional relation between the light-emitting and light-receiving elements shown in FIG. 3;

FIG. 5 is a view showing light reflection factors of a seat cushion frame and an interior wall face as a function of wavelength;

FIG. 6 is a view showing a change in the incident intensities of direct and reflected optical signals at the light-receiving element with lapse of time;

FIG. 7 is a view depicting a positional relation between light-emitting and light-receiving elements in an optical signal transmission device according to a second embodiment of this invention;

FIG. 8 is a schematic view of the light-emitting element shown in FIG. 7;

FIG. 9 is a schematic view showing a positional relation between a light-emitting element, light-receiving element and reflector in an optical signal transmission device according to a third embodiment of this invention;

FIG. 10 is a schematic view showing a positional relation between a light-emitting element, light-receiving element and reflector in an optical signal transmission device according to a fourth embodiment of this invention;

FIG. 11 is a view showing a directivity characteristic of a typical light-emitting element;

FIG. 12 is a view showing a directivity characteristic of a typical light-receiving element;

FIG. 13 is a schematic plan view showing a positional relation between a seat switch unit and a position control unit in an optical signal transmission device according to a fifth embodiment of this invention;

FIG. 14 is a fragmentary view showing a board of the seat switch unit shown in FIG. 13 and a light-emitting element mounted to the board;

FIG. 15 is a schematic plan view showing a board of the position control unit shown in FIG. 13 and a light-receiving element mounted thereto;

FIG. 16 is a schematic side view of the board and the light-receiving element which are shown in FIG. 13;

FIG. 17 is a view depicting a positional relation between the light-emitting element, light-receiving element and reflector in the device according to the fifth embodiment;

FIG. 18 is a schematic perspective view showing a center cluster and an air conditioner unit that are provided with an optical signal transmission device according to a sixth embodiment of this invention;

FIG. 19 is a schematic view showing a positional relation between light-emitting and light-receiving elements in the transmission device of the sixth embodiment; and

FIG. 20 is a view depicting a positional relation between the light-emitting element, light-receiving element and reflector shown in FIG. 19.

### DETAILED DESCRIPTION

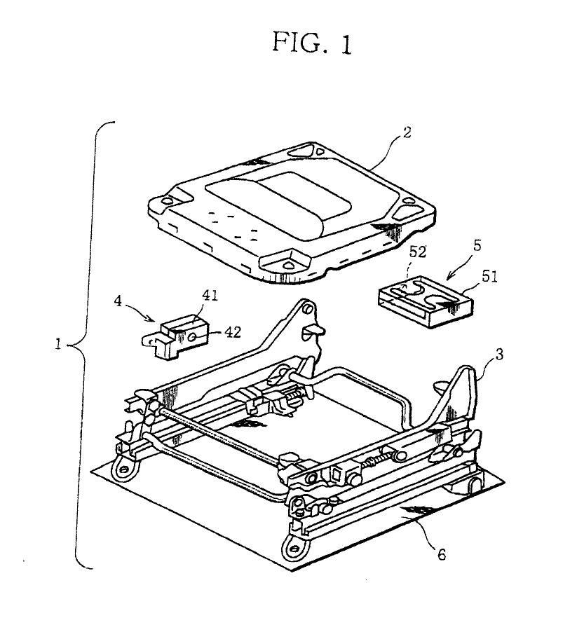

With reference to FIGS. 1-6, an optical signal transmission device according to a first embodiment of the present invention will be explained.

In FIG. 1, a seat unit 1 on which an optical signal transmission device of this invention is mounted is comprised of a seat cushion frame 2 supporting a seat (not shown), a seat adjuster 3 that supports the seat cushion frame 2 and is disposed underneath the seat cushion frame 2 and above a floor mat 6 arranged on a vehicle floor, a seat switch unit (hereinafter referred to as “SW unit”) 4 attached to a cushion shield (not shown), and a position control unit (hereinafter referred to as “ECU”) 5 attached to the seat adjuster 3.

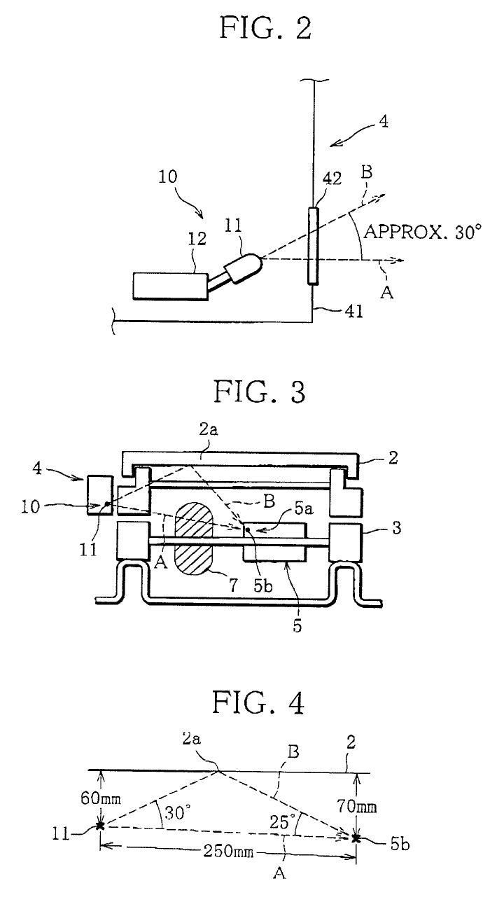

As shown in FIGS. 2 and 3, the transmission device is comprised of an emitter 10 and a receiver 5a accommodated In the SW unit 4 and the ECU 5, respectively. The emitter 10 is comprised of a light-emitting element 11 for emitting an optical signal of, e.g., infrared ray, and a board 12 mounted with an emission control circuit for drivingly controlling the light-emitting element 11 in response to a switch signal supplied from a seat switch (not shown) provided in the SW unit 4. The SW unit 4 has a cabinet 41 provided with an emission window 42 of glass, plastic or the like. As shown in FIG. 1, a cabinet 51 of the ECU 5 is formed with a reception window 52 of glass, plastic or the like.

In the transmission device, an optical signal emitted from the light-emitting element is comprised of signal components that are emitted in various directions with respect to the optical axis of the light-emitting element 11. The optical signal passes through the emission window 42 and propagates through a free space toward the ECU 5. Hereinafter, an optical-signal propagation path extending between the light-emitting and light-receiving elements 11, 5b will be referred to as a first propagation path A, and an optical-signal propagation path extending between the light-emitting element 11, a particular part (reflector) 2a of the seat cushion frame 2, and the light-receiving element 5b will be referred to as a second propagation path B. A signal component propagating along the first propagation path A will be referred to as a first optical signal, direct optical signal, or direct light. A signal component propagating along the second propagation path B will be referred to as a second optical signal, reflected optical signal, or reflected light Symbols A and B will be sometimes affixed individually to the first and second optical signals.

The first and second optical signals A and B are received by the light-receiving element 5b of the ECU 5 through the reception window 52 of the ECU 5 that operates the seat adjuster 3 in accordance with the optical signals. In a strict sense, the second optical signal delays behind the first optical signal due to the path difference between the first and second propagation paths A and B. However, this delay is negligible in the signal transmission since the distance between the light-emitting and light-receiving elements is extremely small as compared to the propagation speed of the optical signal.

In the present embodiment, the SW unit 4 and the ECU 5 are arranged as shown in FIGS. 3 and 4. More specifically, the distance between the light-emitting and light-receiving elements 11, 5b is set to 250 mm, and the vertical distances between the light-receiving element 5b and the seat cushion frame 2 and between the light-emitting element 11 and the seat cushion frame 2 are set to 60 mm and 70 mm, respectively, so that the vertical distance between the light-emitting and light-receiving elements 11, 5b is 10 mm.

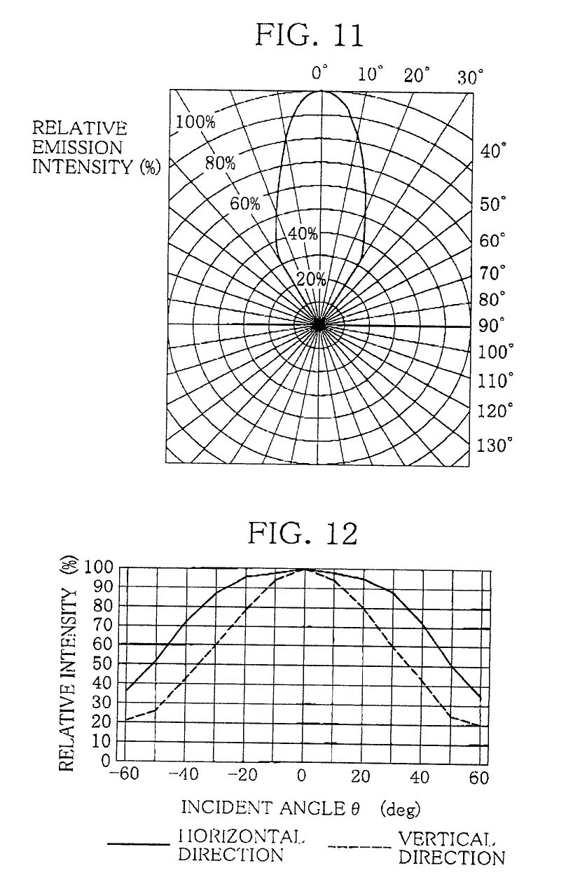

First and second angles formed individually between the first propagation path A and an upstream section of the second propagation path B and between the first propagation path A and a downstream section of the second propagation path B are determined geometrically in dependence on the positional relationship between the light-emitting element 11, reflector 2a and light-receiving element 5b. In the arrangement exemplarily shown in FIGS. 3 and 4, the first and second angles are about 30 deg and about 25 deg, respectively. The light-emitting element 11 has a directivity characteristic shown in FIG. 11 and is arranged that its optical axis coincides with the upstream section of the second propagation path B. That is, the first propagation path A extends at an angle of 30 deg with respect to the optical axis of the light-emitting element 11. The light-receiving element 5b has a directivity characteristic shown in FIG. 12 and is arranged that its optical axis is directed to between the first propagation path A and the downstream section of the second propagation path B.

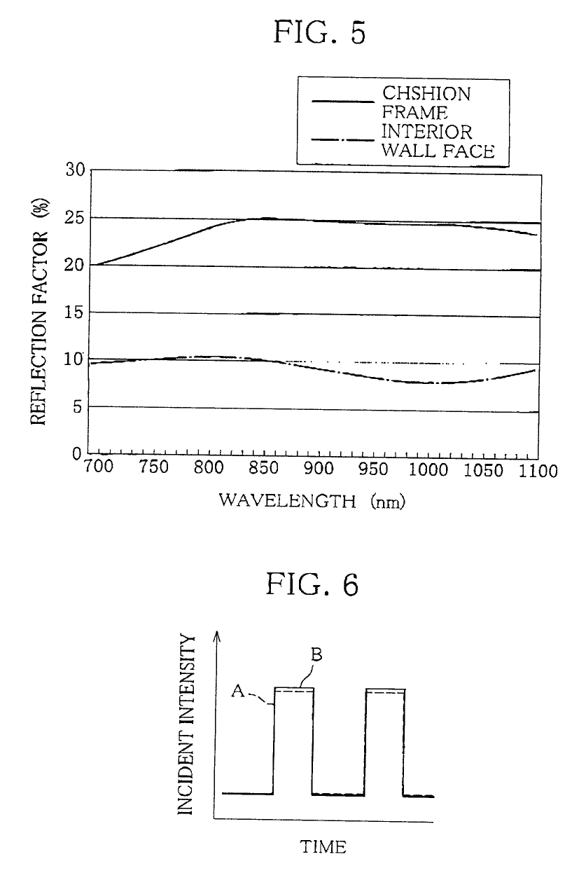

In the exemplary arrangement, the emission intensities of the first and second optical signals A and B are 20-30% and 100% of the maximum emission intensity of the light-emitting element 11 (i.e., the emission intensity observed in the direction of its optical axis), respectively. The reflection factor of the seat cushion frame 2 forming the reflector 2a is represented as a function of wavelength of optical signal, as shown by the solid line in FIG. 5. For the optical signal in this embodiment varying in wavelength range from 850 nm to 950 nm, the reflection factor of the reflector 2a is approximately 25%. Meanwhile, the reflection factor of an interior wall face of the seat cushion frame is approximately 10%, as shown by the one-dotted chain line in FIG. 5. In view of the reflectivity characteristic and the orientation of the light-receiving element 5b, the input levels of the first and second optical signals A and B to the light-receiving element 5b are nearly equal to each other.

Since the direct optical signal emitted from the light-emitting element 11 at a lower intensity is directly received by the light-receiving element 5b, whereas the reflected optical signal emitted at a higher intensity is reflected by the reflector, the incident intensities of the direct and reflected optical signals to the light-receiving element 5b are nearly equal to each other as shown in FIG. 6. That is, in this embodiment, the ratio of the incident intensity of the reflected optical signal to the incident intensity of the direct optical signal is about 100%. However, in the present invention, this ratio may be 25% or higher to perform a suitable optical signal transmission.

With this embodiment, even if the direct light A is blocked by an obstacle 7, the reflected light B, having an incident level equivalent to that of the direct light A, enters into the light-receiving element 11, so that the optical signal of a level which is about one half of the ordinary level may enter into the light-receiving element 11. As a result, a reliable optical signal transmission can be achieved even if the direct light A is blocked by an obstacle such as a movable part of the seat adjuster 3 or a wire harness that may be moved into the first optical-signal propagation path of the device.

For the reason that the difference between the sensitivities of the light-receiving element 5b in receiving the direct and reflected optical signals is small since the optical axis of the light-receiving element 11 is directed to between the direct-light and reflected-light propagation paths A and B, there is no need of providing an amplifier circuit or a highly sensitive light-receiving element in the receiver 5a, resulting in a reduced manufacturing cost.

Since the reflector 2a of this embodiment may be constructed by the seat cushion frame 2 which is an existing seat-unit component and which has a low reflection factor, it is unnecessary to take a special measure such as providing a reflector having a high reflection factor or attaching a reflection member having a high reflection factor, e.g., an aluminum vapor-deposited film, to the seat cushion frame 2, making it possible to reduce the manufacturing cost.

Furthermore, it is unnecessary to make the optical axis of the light-emitting element 11 of the SW unit 4 coincide with that of the light-receiving element 5b of the ECU 5 upon installation of the SW unit 4 and the ECU 5 on the seat unit 2. This eliminates the need of fine positional tuning for the SW unit 4 and the ECU 5, contributing to a reduction in manufacturing cost.

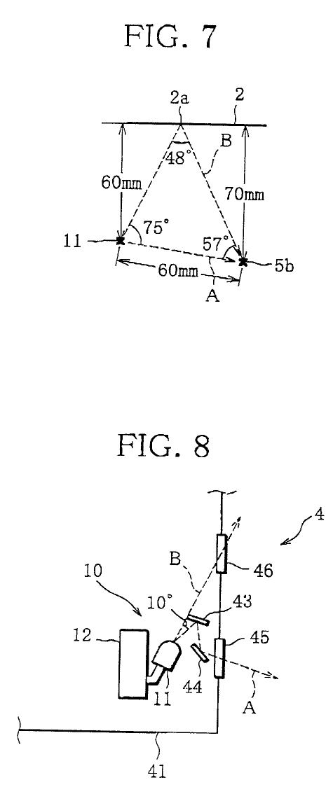

In the following, an optical signal transmission device according to a second embodiment of this invention will be explained with reference to FIGS. 7 and 8.

This embodiment contemplates implementing an appropriate optical signal transmission even with use of an arrangement having a small distance between the light-emitting and light-receiving elements and hence a relatively large angle between the first and second propagation paths A and B In an arrangement having the first and second propagation paths forming a moderate angle therebetween, the incident levels of the direct and reflected light signals to the receiver can be made proper by, for example, arranging the light-emitting element to have its optical axis coincident with the second propagation path as in the case of the first embodiment. On the contrary, it is difficult to obtain the direct and reflected light signals of required incident levels in an arrangement where a large angle is formed between the first and second propagation paths, in view of the directivity characteristic of the light-emitting element.

The transmission device of this embodiment is so arranged that the uppermost section of the first propagation path A extends at a relatively small angle with respect to the optical axis of the light-emitting element to increase the emission intensity of the first optical signal from the light-emitting element and that two reflector plates are provided in that section of the first propagation path which extends in the emitter, to thereby extend, on the downstream side of the emitter, the first propagation path A at a large angle relative to the second propagation path B. Further, the second propagation path B is arranged to coincide with the optical axis of the light-emitting element (more generally, to extend at a relatively small angle with respect to the optical axis of the light-emitting element) . That is, the transmission device of this embodiment makes it possible to attain desired emission intensities of the first and second optical signals from the light-emitting element even in an arrangement where the first and second propagation paths A and B form a large angle therebetween.

More specifically, as shown in FIG. 7, the distance between the light-emitting and light-receiving elements 11, 5b is set to 60 mm, the first propagation path A and an upstream section of the second propagation path B form an angle of about 75 degree therebetween, and the first propagation path A and a downstream section of the second propagation path B form an angle of about 57 degree therebetween. The light-emitting and light-receiving elements 11, 5b are arranged that their optical axes coincide with the upstream and downstream sections of the second propagation path B, respectively. As shown in FIG. 8, the SW unit 4 has a cabinet 41 formed with windows 45, 46, and two reflector plates 43, 44 are provided within the SW unit 4. The reflection plates 43, 44 is comprised of a member having a reflection factor of, e.g., 90%. The reflection plate 43 disposed at a location close to the light-emitting element 11 serves to reflect the first optical signal emitted from the light-emitting element 11 toward the reflection plate 44.

The first optical signal propagates along the uppermost section of the first propagation path A extending at an angle of 10 deg with respect to the optical axis of the light-emitting element. The first optical signal reflected by the reflection plate 44 is emitted to a free space through the window 45, and propagates toward the light-receiving element 5b along the downstream section of the first propagation path A, which extends, on the side downstream of the emitter 10, at an angle of about 75 deg relative to the second propagation path B.

On the other hand, the second optical signal, emitted from the light-emitting element 11 and passing through the window 46, propagates through a free space toward the particular part of the seat cushion frame 2, i.e., the reflector 2a. The seat cushion frame 2 made of iron has a reflection factor of about 25% at an optical signal wavelength ranging from 850 nm to 950 nm (see, FIG. 5). The second optical signal reflected by the reflector 2a propagates to the light-receiving element 5b.

The incident intensity of the second optical signal B to the light-receiving element 5b is equal to a value obtained by multiplying the maximum optical-signal emission intensity of the light-emitting element 11 by the reflection factor of the reflector 2a, the value being about 25% of the maximum emission intensity of the light-emitting element 11.

On the other hand, the emission intensity of the first optical signal A emitted from the light-emlttlng element 11 at an angle of 10 deg with respect to the optical axis of the light-emitting element is about 80% of the maximum emission intensity in view of the directivity of the light-emitting element 11 shown in FIG. 11. The first optical signal A is reflected by the reflection plates 43, 44 each having a reflection factor of 90%, and then enters into the light-receiving element 5b at an angle of about 57 deg with respect to the optical axis of the light-receiving element. As understood from the directivity of the light-receiving element 5b, the first optical signal enters into the light-receiving element 5b at an input level which is about 40% of the maximum optical-signal incident intensity of the light-receiving element 5b. The incident intensity of the first optical signal A to the light-receiving element 5b is equal to a value obtained by multiplying the emission intensity of the first optical signal A by the product of the reflection factors of the reflection plates 43, 44 and the input level of the first optical signal A to the light-receiving element 5b, the value being about 25% of the maximum emission intensity of the light-emitting element 11.

As apparent from the foregoing explanation, in the device of this embodiment, both the incident intensities of the first and second optical signals A, B to the light-receiving element 5b are about 25% of the maximum emission intensity of the light-emitting element 11, and thus they are nearly equal to each other. Therefore, even if the direct light A is blocked by an obstacle 7, the optical signal enters into the light-receiving element 5b at an input level which is one half of the ordinary input level, so that a reliable optical signal transmission is achieved.

In addition, the transmission device of this embodiment, which is provided with the reflector plates 43, 44 at the upstream section of the first optical-signal propagation path A to thereby suppress the difference between emission intensities of the first and second optical signals emitted from the light-emitting element 11 and increase the angle formed between the first and second propagation paths A and B, ensures the optical signal transmission avoiding the obstacle 7 on the first propagation path A even in a device configuration having a small distance between the light-emitting and light-receiving elements. It is easy to fabricate the reflector plates 43, 44 having a high reflection factor, which may be comprised of an iron plate having an outer surface to which an aluminum film is affixed.

In a strict sense, the second optical signal B delays behind the first optical signal A due to the presence of the path difference therebetween, however, such a delay is negligible in optical signal transmission since the distance between the light-emitting and light-receiving elements is very short as compared to the propagation speed of optical signal.

To construct the optical signal transmission device of a type suppressing the emission intensity difference between the first and second optical signals and having a large angle, e.g., of about 75 deg between the first and second propagation paths A, B, two light-emitting elements for individually emitting the first and second optical signals may be provided in the emitter 10, instead of using the device configuration of the second embodiment. In this case, the light-emitting elements for the first and second optical signals maybe arranged, with their optical axes coincident individually with the first and second propagation paths. As apparent from the explanation as to the second embodiment, the light-emitting element for the second optical signal is only required to have an emission intensity which is about 40 of that of the common light-emitting element of the second embodiment for emitting both the first and second optical signals, making it possible to make the emitter compact and reduce the manufacturing cost. If the light-emitting element for the second optical signal is of the same type as the common light-emitting element, an operating current therefor can be reduced to about 40% of that for the common light-emitting element.

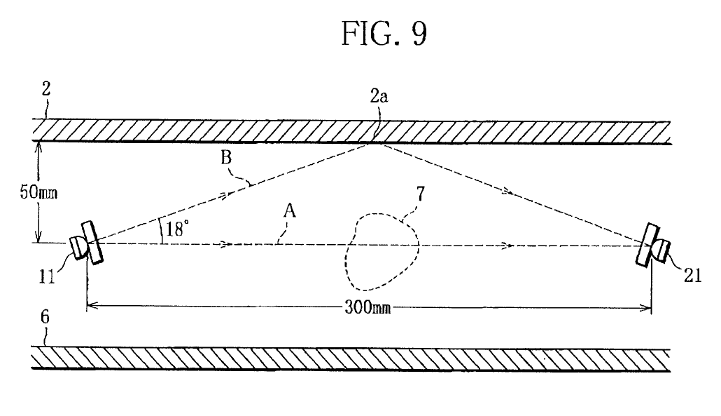

Next, with reference to FIG. 9, an optical signal transmission device according to a third embodiment of the present invention will be explained.

The device of this embodiment contemplates preventing a faulty transmission caused by dust adhered to the device. In an optical signal transmission device for a seat unit, which is of a type arranged underneath a seat and above a floor mat disposed on the vehicle floor, dust rises from the floor mat, e.g., when a passenger gets on or out of the vehicle and is adhered to the emitter and the receiver of the transmission device. This lowers an amount of the optical signal, e.g., of infrared ray that is emitted from the emitter and enters into the receiver, so that a faulty transmission may be caused. To take measures against such a problem, the device may be disposed away from the floor mat, thereby preventing the adherence of dust to the device, in particular, the adherence of dust having a large particle size and liable to cause a faulty transmission. However, there is a restriction as to the location available for installation of the transmission device for seat unit, making it difficult to take such measures.

In this embodiment, the light-emitting element 1 of the emitter and the light-receiving element 21 of the receiver are disposed to be directed upward, i.e., in a facing relation with the seat cushion frame, thereby preventing dust rising from the floor mat 6 from being adhered to these elements.

The device of this embodiment has the same basic configuration as that of the first embodiment, and will be explained in brief.

The light-emitting element 11 is arranged that its optical axis coincides with the upstream section of the second optical-signal propagation path B, and the light-receiving element 21 is disposed, with its optical axis directed to between the first propagation path A and the downstream section of the second propagation path B. The distance between the light-emitting and light-receiving elements 11, 21 is set to 300 mm, the distances between the seat cushion frame 2 and the light-emitting element 11 and between the frame 2 and the light-receiving element 21 are set to 300 mm and 50 mm, respectively. Thus, the first optical-signal propagation path A and the upstream section of the second propagation path B form an angle about 18 deg therebetween, and the first propagation path A and the downstream section of the second propagation path B form an angle of about 18 deg therebetween.

The light-emitting element 11 has the directivity shown in FIG. 11. Thus, the emission intensity of the second optical signal, emitted from the light-emitting element 11 to the direction of the upstream section of the second propagation path B disposed to coincide with the optical axis of the light-emitting element 11, is equal to the maximum emission intensity 100% of the light-emitting element. The second optical signal B is reflected by the seat cushion frame 2 serving as the reflector 2a having a reflection factor of about 25%, and then enters into the light-receiving element 21. The incident intensity of the second optical signal (reflected light) B into the light-receiving element 21 is about 25% of the maximum emission intensity of the light-emitting element 11.

On the other hand, the emission intensity of the first optical signal, emitted from the light-emitting element 11 in the direction of the first propagation path A extending at an angle of about 18 deg with respect to the optical axis of the light-emitting element 11, is about 50% of the maximum emission intensity of the light-emitting element 11. The first optical signal propagates through a free space from the light-emitting element 11 to enter the light-receiving element 21, and thus the incident intensity of the first optical signal (direct light) A to the light-receiving element 21 is about 50% of the maximum emission intensity of the light-emitting element.

In this embodiment, the incident intensity of the reflected light B into the light-receiving element 21 is one half of that of the direct light A, as mentioned above. Thus, the optical signal enters into the light-receiving element 21 at an input level which is one-third of the ordinary input level, even if the direct light A is blocked by an obstacle 7, whereby a faulty transmission can be prevented.

As explained, this embodiment can attain advantages similar to those of the first embodiment, and can also prevent the adherence of dust, rising from the floor mat 6, to the light-emitting and light-receiving elements by the upward installation of these elements.

In the following, an optical signal transmission device according to a fourth embodiment of this invention will be explained.

The transmission device of this embodiment contemplates ensuring a proper optical signal transmission even in an arrangement having the light-emitting and light-receiving elements disposed close to the reflector, and preventing adherence of duct to these elements.

In an optical signal transmission device for seat unit, dust adhered to the emitter and the receiver is mainly comprised of dust rising from the floor mat 6, and the adherence of dust having a large particle size is a main cause of a faulty transmission. In the device of this embodiment, the reflector is constituted by part of the seat cushion frame 2 located away from the floor mat 6 and the light-emitting and light-receiving elements are placed at locations close to the seat cushion frame 2 in order to prevent the adherence of a large-sized dust. In general, however, if the emitter and the receiver are located close to the seat cushion frame 2, then an excessively small angle is formed between the direct-light propagation path and the reflected-light propagation path. This makes it difficult for the reflected light to propagate from the emitter to the receiver while going around an obstacle on the direct-light propagation path. In this regard, the device of this embodiment is configured that two paths extending between the emitter, reflector and receiver are provided in the vicinity of the seat cushion frame 2, so that optical signals may propagate along these paths irrespective of the presence or absence of an obstacle.

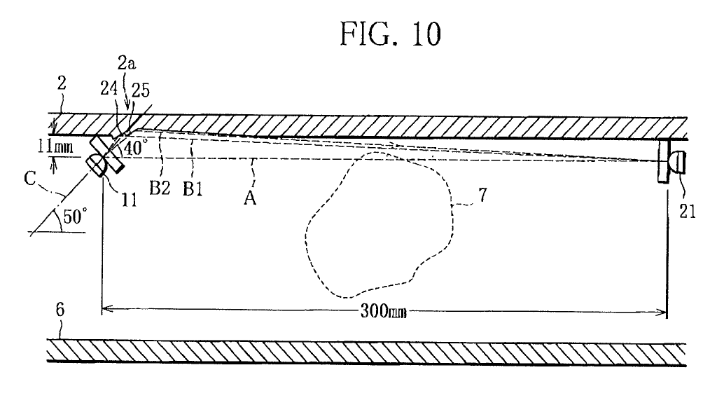

More specifically, as shown in FIG. 10, the light-emitting and light-receiving elements 11, 21 are disposed close to the seat cushion frame 2 and away from the floor mat 6. The light-emitting element 11 is installed at a location vertically 11 mm away from the seat cushion frame 2 and arranged obliquely upward, with its optical axis C extending at an angle of 50 deg with respect to an imaginary line A connecting the light-emitting and light-receiving elements 11, 21. Since the light-emitting element 11 has the directivity shown in FIG. 11, the optical-signal emission intensity of the light-emitting element 11 measured in the direction of the imaginary line A is nearly 0% of the maximum optical-signal emission intensity of the light-emitting element. That is, the optical signal emitted to the direction of the imaginary line A is negligible in optical signal transmission. The light-receiving element 21 is installed at a location about 10 mm away from the seat cushion frame 2 as viewed in the vertical direction of the transmission device.

That part of the seat cushion frame 2 which faces the light-emitting element 11 serves as the reflector 2a having a reflection factor of about 25% for the optical signal whose wavelength varies from 850 nm to 950 nm. The reflector 2a is formed with two slanted reflection planes 24, 25. The reflection plane 24 is formed in that part of the seat cushion frame which intersects with an imaginary line (hereinafter, referred to as an upstream section of a first propagation path B1) extending from the light-emitting element 11 at an angle of 60 deg with respect to the imaginary line A. The reflection plane 24 extends obliquely with respect to the upstream section of the first propagation path B1, so as to reflect the optical signal toward the light-receiving element 21. The reflection plane 25 is formed in that part of the seat cushion frame which intersects with an imaginary line (hereinafter, referred to as an upstream section of a second propagation path B2) extending from the light-emitting element 11 at an angle of 40 deg with respect to the imaginary line A. The reflection plane 25 extends obliquely with respect to the upstream section of the second propagation path B2, thereby reflecting the optical signal toward the light-receiving element 21. Hereinafter, the optical signals that propagate in a free space from the light-emitting element 11 to the light-receiving element 21 along the first and second propagation paths B1, B2 will be referred to as first and second optical signals (or first and second reflected light signals), respectively.

As apparent from the foregoing explanation, the upstream sections of the first and second propagation paths B1, B2 extend at an angle of 10 deg with respect to the optical axis of the light-emitting element 11, respectively, and hence the emission intensities of the first and second optical signals emitted from the light-emitting element 11 in the directions of the first and second propagation paths are about 80% of the maximum emission intensity of the light-emitting element 11 in view of its directivity shown in FIG. 11. The first and second optical signals are reflected by the reflection planes 24 and 25, respectively, and then enter into the light-receiving element 21 disposed such that its optical axis is directed to between downstream sections of the first and second propagation paths B1, B2. Thus, the input levels of the first and second optical signals are substantially the same as the maximum optical-signal input level of the light-receiving element 21.

As already explained, the transmission device of this embodiment is designed to effect optical signal transmission based on the first and second optical signals irrespective of whether or not an obstacle is present. These optical signals never be blocked, even if an obstacle 7 exemplarily shown in FIG. 10 is present at a location close to the seat cushion frame 2. If the incident level of optical signal to the light-receiving element 21 is equal to or higher than about 20% of the maximum incident intensity, no faulty transmission may be caused, although the minimum Incident level varies depending on types of the light-receiving element. With the device of this embodiment, a faulty transmission can be prevented.

In addition, since the light-emitting and light-receiving elements 11, 21 of this embodiment are located away from the floor mat 6, there is a low possibility of dust, in particular, large-size dust being adhered to these elements after rising from the floor mat 6. Especially, the light-emitting element 11 disposed obliquely upward is free from adherence of dust.

The transmission device of the fourth embodiment may be modified variously. For example, In the fourth embodiment, two optical-signal propagation paths are formed by two reflection planes provided at the reflector comprised of the seat cushion frame. Instead, a single reflector plane or three or more reflector planes may be provided at the reflector so as to form a single optical-signal propagation path or three or more propagation paths. In this case, the transmission device is configured that the optical-signal incident intensity to the light-receiving element become equal to or higher than about 20% of the maximum incident intensity in order to prevent a faulty transmission. To this end, a reflector member having a high reflection factor may be affixed to the reflector plane.

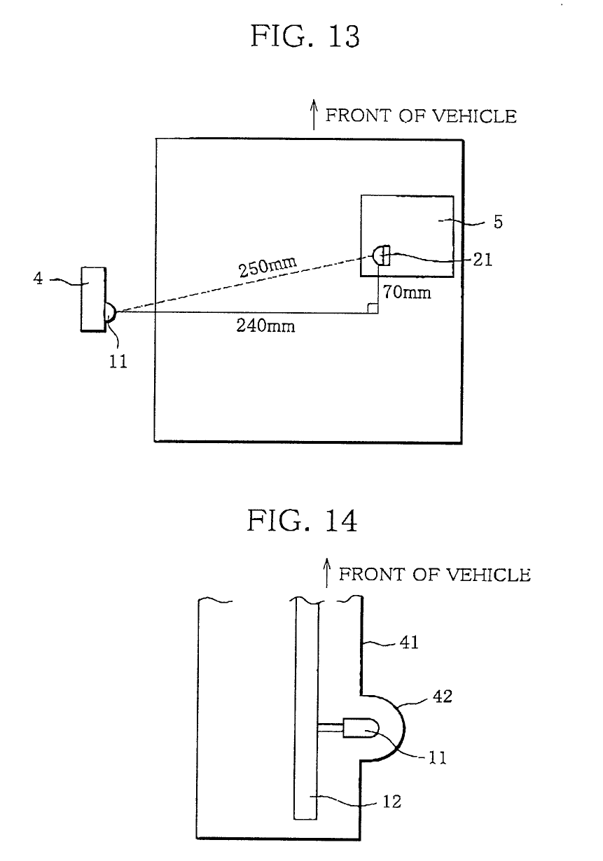

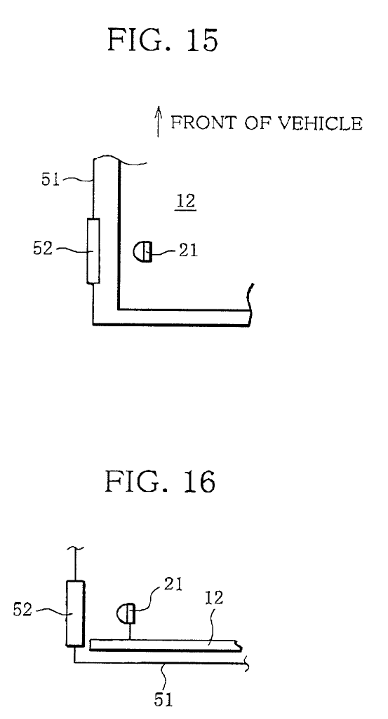

Next, with reference to FIGS. 13-17, an optical signal transmission device according to a fifth embodiment of this invention will be explained.

The basic configuration of the device of this embodiment is substantially the same as that of the first embodiment.

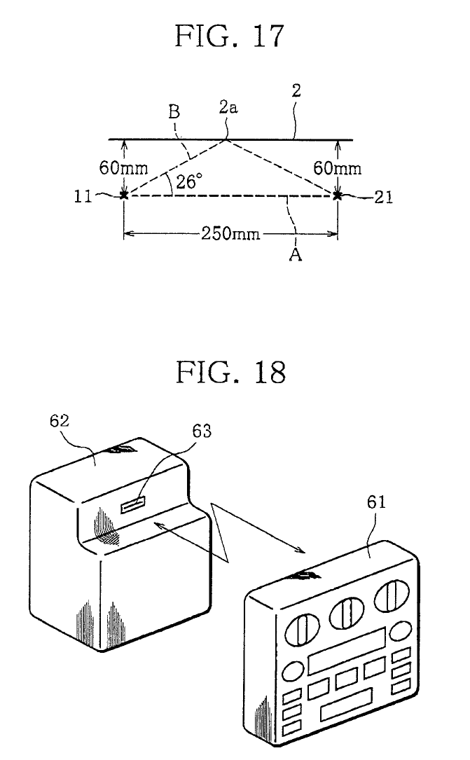

As shown in FIGS. 13-16, the light-emitting element 11 is vertically mounted on a board 12 accommodated in the SW unit 4, and the light-receiving element 21 is vertically mounted on a board 12 of the ECU 5. The light-emitting and light-receiving elements 11, 21 are separated from each other at distances of 70 mm and 240 mm in the longitudinal and width directions of a vehicle, respectively. Thus, the distance between these elements 11, 21 is 250 mm. As shown in FIG. 17, the vertical distances between the light-emitting element 11 and the seat cushion frame 2 and between the light-receiving element 21 and the seat cushion frame 2 are set at 60 mm. An angle of about 26 deg is formed between the first propagation path A extending between the light-emitting and light-receiving elements 11, 21 and an upstream section of the second propagation path B extending between the light-emitting element 11 and the reflector 2a (i.e., a particular part of the seat cushion frame 2). An angle of about 26 deg is formed between the first propagation path A and a downstream section of the second propagation path B. In the following explanation, it is assumed that the light-emitting and light-receiving elements 11, 21 are disposed at substantially the same level as viewed in the vertical direction of the vehicle, although the light-emitting element 11 is actually disposed, e.g., at a location 10-20 mm lower than the light-receiving element in the vertical direction.

The optical axis of the light-emitting element 11 extends at angles of about 16 deg and about 10 deg with respect to the first propagation path A and the upstream section of the second propagation path B. The optical axis of the light-receiving element 21 extends at an angle of about 13 deg with respect to the first propagation path A and the downstream section of the second propagation path B. The light-emitting and light-receiving elements 11, 21 have their directivity characteristics shown in FIGS. 11 and 12, respectively.

In the aforementioned configuration, the emission intensity of the first optical signal (direct light), emitted from the light-emitting element 11 in the direction of the first propagation path extending at an angle of about 16 deg with respect to the optical axis of the light-emitting element, is approximately 70% of the maximum optical-signal emission intensity of the light-emitting element 11. The input level of the first optical signal entering at an angle of about 16 deg to the light-receiving element 21 is approximately 95% of the maximum optical-signal Input level of the light-receiving element. Thus, the incident intensity of the first optical signal to the light-receiving element is about 66% of the maximum optical-signal emission intensity of the light-emitting element 11. On the other hand, the emission intensity of the second optical signal (reflected light), emitted from the light-emitting element 11 in the direction of the upstream section of the second propagation path extending at an angle about 30 deg with respect to the optical axis of the light-emitting element, is approximately 25% of the maximum optical-signal emission intensity of the light-emitting element 11. The second optical signal is reflected by the reflector 2a, which is formed by an aluminum film having a 75% reflection factor and affixed to the seat cushion frame 2, and enters into the light-receiving element 21 at an angle about 30 deg. Thus, the input intensity of the second optical signal to the light-receiving element is about 17% of the maximum optical-signal emission intensity of the light-emitting element 11, whereas the input intensity of the first optical signal to the light-receiving element is about 25% of the maximum optical-signal emission intensity of the light-emitting element. As a consequence, even if the first optical signal (direct light) is blocked by an obstacle, the second optical signal enters into the light-receiving element 21 at a level of about 20% of the ordinary optical-signal input level, whereby a faulty transmission is prevented.

The transmission device of this embodiment may be modified in various manners. For example, the seat cushion frame 2 may not be provided with the reflector of a high reflection factor. In this case, the reflector may be comprised of a particular part of the seat cushion frame of about 25% reflection factor, as in the first embodiment. In addition to such a reflector, one or more slanted reflection planes are preferably provided in the seat cushion frame 2 as in the fourth embodiment to provide two or more reflectors in total, so that two or more reflected light optical signals may enter into the light-receiving element, thereby positively preventing a faulty transmission when the direct optical signal is blocked.

According to this embodiment, advantages similar to those of the first embodiment can be attained. In addition, it is unnecessary to use fixing jigs for the light-emitting and light-receiving elements and make tuning on these elements after production of the transmission device since the light-emitting and light-receiving elements are vertically mounted to boards, whereby manufacturing costs can be reduced.

In the following, with reference to FIGS. 18-20, an optical signal transmission device according to a sixth embodiment of this invention will be explained.

The transmission device of this embodiment is adapted for optical signal transmission between a center cluster and an air conditioner unit of a vehicle.

As shown in FIGS. 18-20, the center cluster 61 is provided with a light emitting and receiving unit 61a that cooperates with a number of switches to control the operation of the air conditioner unit 62 and an audio system (not shown) mounted to the vehicle. The center cluster is fixed to the instrument panel, not shown, of the vehicle. The air conditioner unit 62, which is comprised of an air conditioner controller, a blower motor (none of which is shown), and a light emitting and receiving unit 63, is fixed to a body member within the instrument panel.

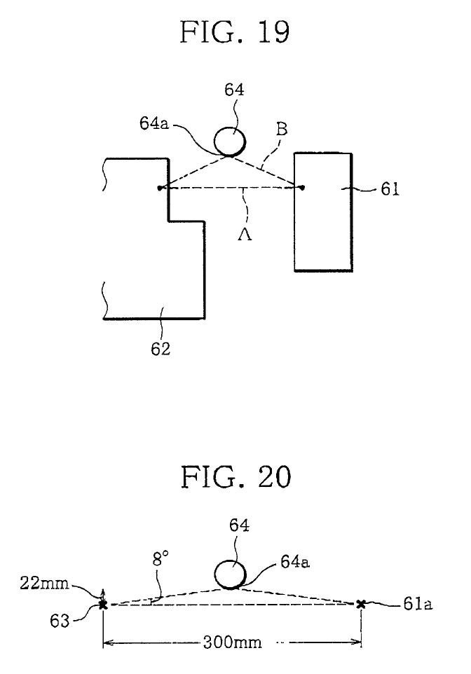

The transmission device of this embodiment comprises the light emitting and receiving unit 61a of the center cluster 61 and the light emitting and receiving unit 63 of the air conditioner unit 62. Each light emitting and receiving unit is comprised of an emitter and a receiver. The emitter includes a board that is mounted with a light-emitting element for generating an optical signal, e.g., of infrared ray and an emission control unit for controlling the light-emitting element. The receiver includes a light-receiving element for receiving an optical signal emitted from the light-emitting element. Various optical signals are transmitted between the units 61a and 63. For example, an optical signal for air conditioner control is transmitted from the unit 61a of the center cluster 61 to the unit 63 of the air conditioner unit 62, and an optical signal for illumination of an indicator is transmitted from the unit 63 to the unit 61a. The center cluster 61 and the air conditioner unit 62 have cabinets thereof each provided with a window member of glass or plastic for optical signal transmission. As shown in FIG. 19, a reinforcement 64 extends between the center cluster 61 and the air conditioner unit 62. A particular part of the reinforcement 64 constitutes a reflector 64a. The reinforcement 64 is made of iron and has a reflection factor of 65% as indicated in Table 2 shown below. In FIGS. 19 and 20, symbol A denotes a first optical-signal propagation path extending between the units 61a, 63, and symbol B denotes a second optical-signal propagation path extending between the unit 61a, reflector 64a and unit 63. As shown in FIG. 20, the distance between the units 61a, 63 is 300 mm, and the reinforcement 64 is separated 22 mm away from the first propagation path A in the vertical direction. In this configuration, an angle of about 8 deg is formed between the first propagation path A and a section of the second propagation path B on the center-cluster side and between the first propagation path A and another section of the second propagation path B on the air-conditioner-unit side. The light-emitting and light-receiving elements of each of the units 61a, 63 arranged with their optical axes directed to between the first and second propagation paths A and B, so that each optical axis extends at an angle of about 4 deg with respect to a corresponding one of the propagation paths A, B. In FIGS. 18 and 19, reference numerals 61b and 61c denote the light-emitting and light-receiving elements of the light emitting and receiving unit 61a, respectively, and 63a and 63b denote those of the unit 63.

The emission intensities of the first and second optical signals, emitted from the light-emitting elements of the units 61a, 63 in the direction of the first and second propagation paths extending at an angle of about 4 deg with respect to the optical axes of the light-emitting elements, are equal to or higher than about 95% of the maximum optical-signal emission intensity of the light-emitting element. The input levels of the first and second optical signals entering the light-receiving element at an angle of about 4 deg are equal to or higher than about 95% of the maximum optical-signal input level of the light-receiving element. The reflection factor of the reflector 64a is 65%.

Thus, the incident intensity of the first optical signal to the light-receiving element is equal to or higher than about 90% of the maximum optical-signal emission intensity of the light-emitting element. On the other hand, the incident intensity of the second optical signal to the light-receiving element is equal to or higher than about 58% of the maximum optical-signal emission intensity of the light-emitting element. As a consequence, even if the first optical signal (direct light) is blocked by an obstacle, the second optical signal (reflected light) enters into the light-receiving element at a level of about 39% or more of an ordinary optical-signal input level obtained when the first and second optical signals enter thereinto, whereby a faulty transmission is prevented.

The present invention is not limited to the first through sixth embodiments, but may be modified variously within the scope of the inventive concept of this invention.

For instance, the reflected-light propagation path is not limited to one in number, but a plurality of reflected-light propagation paths may be provided. In this case, a plurality of particular portions of a seat cushion frame may serves as reflectors, for instance. If necessary, these reflectors may be formed with slanted reflection planes as in the fourth embodiment.

Instead of the reflector comprised of the seat cushion frame made of iron, the reflector may be comprised of a reflector member such as aluminum and alumina, or may be comprised of the seat cushion frame affixed with such a reflector member. Typical reflection members are listed in Table 2, together with their reflection factors actually measured by use of light of 1 μm wavelength.

TABLE 2

Reflection factor (%)

| | Polish | Rough |
|---|---|---|
| Kind of material | finishing | finishing |
| Aluminum | 95 | 75 |
| (Oxidized) | 60 | 60 |
| Iron | 65 | 65 |
| (Oxidized) | 10-50 | 10-50 |
| Alumina | 60-80 | |
| Cloth | 5-20 | |
| Plastic | 5-20 | |

As understood from Table 2, if the reflector is comprised of aluminum or alumina having a higher reflection factor than iron, then the incident intensity of the reflected optical signal to the emitter becomes higher, so that a faulty optical signal transmission which would be caused when the direct optical signal is blocked may be positively prevented, improving the reliability of transmission.

What is claimed is:

1. An optical signal transmission device, mounted to a vehicle, for propagating an optical signal, used to control operation of a vehicle-mounted apparatus, through a free space along a first propagation path extending from an emitter to a receiver and a second propagation path extending from the emitter to the receiver via a reflector that is disposed outside the emitter and the receiver, the improvement comprising:
an optical axis of a light-emitting element of the emitter or that of a light-receiving element of the receiver being deviated such that a ratio of an incident intensity, at the receiver, of a second optical signal propagating along the second propagation path to an incident intensity, at the receiver, of a first optical signal propagating along the first propagation path is equal to or higher than a predetermined value at or above which a faulty optical-signal transmission is not caused.

2. The optical signal transmission device according to claim 1, wherein at least one of the light-emitting element of the emitter and the light-receiving element of the receiver is disposed upward.

3. The optical signal transmission device according to claim 1, wherein said predetermined value is 25%.

4. The optical signal transmission device according to claim 1, wherein said light-emitting element is disposed that its optical axis coincides with an upstream section, extending from the emitter to the reflector, of the second propagation path.

5. The optical signal transmission device according to claim 1, wherein one or more reflector members are disposed in either or both of upstream sections, extending in the emitter, of the first and second propagation paths.

6. An optical signal transmission device, mounted on a vehicle, for propagating an optical signal, used to control operation of a vehicle-mounted apparatus, through a free space from an emitter to a receiver, the improvement comprising:
said transmission device having a reflector disposed outside the emitter and the receiver and formed with first and second slanted reflection planes; and
said emitter including a light-emitting element having an optical axis thereof deviating from an imaginary line connecting the emitter and the receiver toward the reflector such that a ratio between incident intensities of first and second optical signals, emitted from the emitter, reflected individually by the first and second slanted reflection planes and then entering the receiver, is equal to or higher than a predetermined value at or above which a faulty optical signal transmission is not caused.

7. The optical signal transmission device according to claim 6, wherein said receiver includes a light-receiving element for receiving the first and second optical signals, and at least one of the light-emitting element of the emitter and the light-receiving element of the receiver is disposed upward.

8. The optical signal transmission device according to claim 6, wherein said predetermined value is 25%.

9. The optical signal transmission device according to claim 6, wherein the optical axis of the light-emitting element is set to be directed to between the first and second slanted reflection planes.

10. The optical signal transmission device according to claim 6, wherein said reflector is formed with a curved reflection plane.
